(19) United States
(12) Patent Application Publication
(10) Pub. No.: US 2024/0159910 A1
(43) Pub. Date: May 16, 2024

(54) Method and Apparatus for Localizing Road Users

(71) Applicant: Aptiv Technologies AG, Schaffhausen (CH)

(72) Inventor: Sebastian Papierok, Ratingen (DE)

(21) Appl. No.: 18/509,926

(22) Filed: Nov. 15, 2023

(30) Foreign Application Priority Data
Nov. 15, 2022 (EP) 22207563

(51) Int. Cl. G01S 19/07; G01S 19/39

(52) U.S. Cl. CPC G01S 19/072; G01S 19/396

(57) ABSTRACT

The method disclosed includes determining a first set of parameters associated with a position of the first road user, based on a first set of positioning data associated with the first road user, the first set of positioning data obtained by a first Global Navigation Satellite System (GNSS) receiver located at the first road user. The method includes determining, for each of one or more second road users, a second set of parameters associated with a position of the second road user, based on a corresponding second set of positioning data obtained by a corresponding second GNSS receiver located at the second road user. The method includes determining, for each of the one or more second road users, a relative position of the second road user with respect to the first road user based on the first set of parameters and a corresponding second set of parameters.

### CROSS-REFERENCE TO RELATED APPLICATIONS

This application claims priority to EP App. No. 22 207 563 filed on Nov. 15, 2022, the entire disclosure of which is incorporated by reference.

### FIELD

The present application relates to the field of localization using a Global Navigation Satellite System (GNSS) and, more particularly, to techniques for localizing road users.

### BACKGROUND

Road safety and autonomous driving are important topics in the automotive industry. For some years now, more and more advanced driver assistance systems (ADAS) have been made available. ADAS help to recognize dangerous situations and even actively intervene in the driving situation when the driver has no time to react. For this purpose, surrounding information of a vehicle is collected with the aid of local sensor systems such as radar, lidar and camera. Vehicle-to-vehicle and vehicle-to-infrastructure communication (in short: Car2X communication) can be regarded as another sensor system that operates beyond line-of-sight.

Many Car2X applications require determining positions (i.e., relative positions) of nearby vehicles to recognize dangerous situations. For example, a relative position can be used for estimating a distance between a nearby vehicle and the local vehicle. Based on the estimated distance, advanced driver assistance service can be provided to the driver of the vehicle.

A simple approach to determine a relative position between two vehicles is to calculate a difference between the current positions of the two vehicles. A conventional method to obtain a current position is to use a GNSS receiver to obtain an estimated position based on signals from GNSS satellites. Then, the estimated positions are shared among the vehicles, e.g., via Car2X communication, to determine each other's relative positions. However, the estimated position determined by a low-cost GNSS receiver has only an accuracy of a few meters. In highly dynamic road situations, estimated positions determined by a low-cost GNSS receiver are not accurate enough for the determination of relative positions between different road users. On the other hand, precise systems (e.g., the Differential Global Positioning System (DGPS) or the (Real-Time Kinematic) RTK system) are too expensive and not every road user can be equipped with a GNSS receiver capable of using the precise systems.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

The invention is defined in the independent claims. Various embodiments are subject-matter of the dependent claims.

Furthermore, the GNSS receivers are considered as a black box because the internal algorithms are generally unknown. In addition, the positions calculated in the GNSS receivers might be improved by certain methods (e.g., by applying a Kalman filter). This distorts common errors between two road users, so that an additional error might be introduced in the estimated relative position.

Currently, different alternative approaches are being developed to improve the accuracy of estimated relative positions of nearby vehicles. One approach is to obtain positioning data from GNSS satellites and determine a relative position based on pseudorange double differences (PRDDs) and using a least squares method. This approach is referred to as a PRDD-based approach in the following.

A drawback of the PRDD-based approach is that, positioning data from only common satellites (i.e., jointly visible to two road users) can be used in the determination of the PRDDs. In some use cases, a road user such as an infrastructure unit (e.g., a road side unit (RSU)) can see more satellites compared to another road user (such as a vehicle moving on a road). In those cases, the PRDD-based approach cannot use the positioning data from the extra satellites (which are not visible to the other road user).

Therefore, one goal of the present disclosure is to provide techniques to improve accuracy of estimated relative positions of road users. Further, it is also a goal of the present disclosure to ensure efficiency of the algorithm for improved relative position estimation, so that these techniques can be used in real-time (or almost real-time) to provide real-time (or almost real-time) relative position information to the road user.

The term “road user” refers to any entity that participates in a road system, e.g., a vehicle (e.g., a vehicle moving on a road, a vehicle parked at a roadside), a person (e.g., a person riding/driving a vehicle, a person walking on a roadside or crossing a road), an infrastructure unit (e.g., a roadside unit (RSU)), etc.

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

For example, in an aspect of the disclosure, a computer-implemented method for localizing one or more road users comprises: determining a first set of parameters associated with a position of the first road user, based on a first set of positioning data associated with the first road user, the first set of positioning data obtained by a first Global Navigation Satellite System (GNSS) receiver located at the first road user; determining, for each of one or more second road users, a second set of parameters associated with a position of the second road user, based on a corresponding second set of positioning data obtained by a corresponding second GNSS receiver located at the second road user; and determining, for each of the one or more second road users, a relative position of the second road user with respect to the first road user based on the first set of parameters and a corresponding second set of parameters.

In an additional aspect of the disclosure, an apparatus comprises means for determining a first set of parameters associated with a position of the first road user, based on a first set of positioning data associated with the first road user, the first set of positioning data obtained by a first Global Navigation Satellite System (GNSS) receiver located at the first road user; means for determining, for each of one or more second road users, a second set of parameters associated with a position of the second road user, based on a corresponding second set of positioning data obtained by a corresponding second GNSS receiver located at the second road user; and means for determining, for each of the one or more second road users, a relative position of the second road user with respect to the first road user based on the first set of parameters and a corresponding second set of parameters.

In an additional aspect of the disclosure, a computer program comprises instructions which, when the program is executed by a computer, cause the computer to carry out a method in accordance with some aspects of this disclosure.

In an additional aspect of the disclosure, a non-transitory computer-readable medium has program code recorded thereon and the program code includes code for causing an apparatus to perform a method in accordance with some aspects of this disclosure.

Other aspects, features, and aspects will become apparent to those of ordinary skill in the art, upon reviewing the following description of specific aspects in conjunction with the accompanying figures. While features may be discussed relative to certain aspects and figures below, all aspects can include one or more of the advantageous features discussed herein. In other words, while one or more aspects may be discussed as having certain advantageous features, one or more of such features may also be used in accordance with the various aspects discussed herein. In similar fashion, while aspects may be discussed below as device, system, or method aspects it should be understood that such aspects can be implemented in various devices, systems, and methods.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 illustrates a simple method to determine a relative vector based on exchanging current positions of two road users.

FIG. 2 illustrates a method to determine a relative vector based on a new approach according to some aspects of the disclosure.

FIG. 3 illustrates a method to determine a relative vector based on a new approach according to some aspects of the disclosure.

FIG. 4 illustrates a method to determine a relative vector based on a new approach according to some aspects of the disclosure.

FIG. 5 illustrates a flow diagram of a method to determine a relative vector based on a new approach according to some aspects of the disclosure.

In the drawings, reference numbers may be reused to identify similar and/or identical elements.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

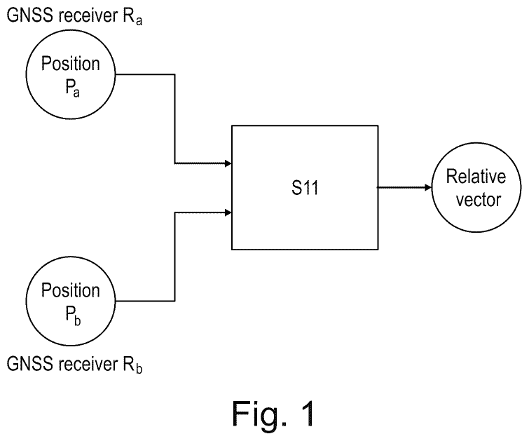

FIG. 1 illustrates a simple method to determine a relative vector based on exchanging current positions of two road users. As shown in FIG. 1, a simple method to determine a relative position (i.e., a relative vector v_ab) between two road users a and b is to determine a difference between two current positions P_a and P_b of the two road users a and b, shown as block S11. The current positions P_a and P_b are determined by corresponding Global Navigation Satellite System (GNSS) receivers R_a and R_b based on positioning signals received from GNSS satellites.

In this approach, however, the GNSS receivers are considered as a black box because the internal algorithms are generally unknown. In addition, the positions calculated in the receivers might be improved by certain methods (e.g., by applying a Kalman filter). This distorts common errors between two road users, so that an additional error may be introduced in the estimated relative vector.

The present disclosure provides techniques to solve this problem by applying a new approach. In the new approach, instead of exchanging the determined current positions, sets of positioning data are exchanged between the road users.

In an aspect, the positioning data may comprise “raw data”. Each GNSS satellite sends signals with a specific code which is different for each satellite. These codes for different GNSS satellites are known at a GNSS receiver. When a signal arrives at a GNSS receiver, the GNSS receiver calculates measurements (e.g., pseudorange measurements), which are referred to as “raw data”.

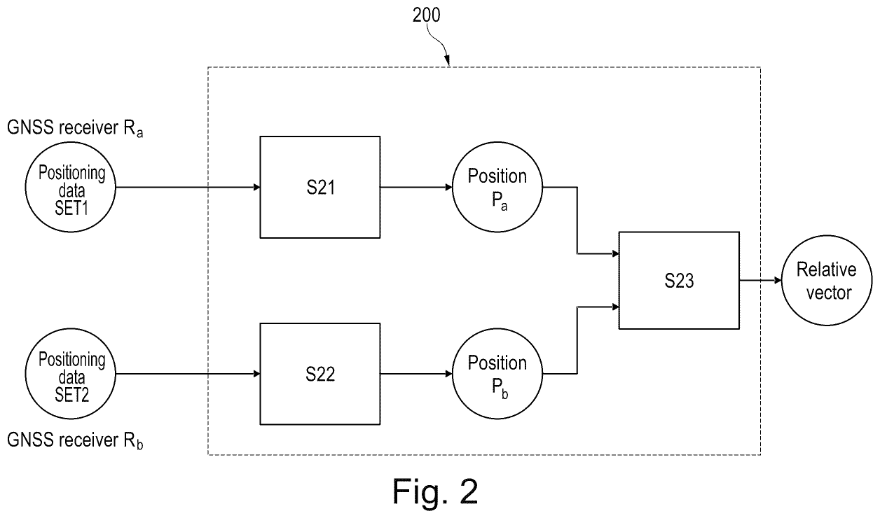

The techniques disclosed herein will be more understandable based on the description with reference to FIG. 2-FIG. 5.

FIG. 2 illustrates a method to determine a relative vector/relative position based on the new approach according to some aspects of the disclosure. For simplification, the method 200 shown in FIG. 2 only shows steps for determining a relative vector between two road users. However, the method can be extended to apply to any number of road users to determine relative vectors/relative positions between different pairs of road users.

Steps of the method 200 can be executed by a computing device (e.g., a processor, processing circuit, and/or other suitable component) or other suitable means for performing the steps.

As shown in FIG. 2, a device receives a set of positioning data (SET1) obtained by a GNSS receiver R_a at the road user a, and receives a set of positioning data (SET2) for a road user b obtained by a GNSS receiver R_b at the road user b.

At block S21, the device determines an estimated current position P_a based on the positioning data of SET1.

At block S22, the device determines an estimated current position P_b based on the positioning data of SET2.

Then, at block S23, the device determines a relative vector v_ab (pointing from the road user a to the road user b) or a relative vector v_ba (pointing from the road user b to the road user a) based on the determined estimated current positions P_a and P_b.

In an aspect, the device for determining the relative vector can be located at the road user a.

In another aspect, the device for determining the relative vector can be located in a cloud system.

In another aspect, the positioning data may be exchanged via C2X communications, Wi-Fi, G5, G6 or any other new technologies.

In another aspect, the positioning data may include timestamp information. The timestamp information can be used to synchronize measurement data in the positioning data for different road users.

By using the new approach as shown in FIG. 2, it can be ensured that a same set of functions/algorithm are used at blocks S21 and S22 so that common errors in the estimated current positions P_a and P_b can be minimized.

Furthermore, by using the new approach as shown in FIG. 2, the set of functions/algorithm used at blocks S21 and S22 can be simplified to obtain less accurate estimated current positions P_a and P_b. The set of functions/algorithm are simplified in such a way, that the errors caused by the simplification are similar in the estimated position P_a and in the estimated position P_b. Thus, those errors in [symbol] P [symbol] _a and P_b can cancel each other out during the difference calculation at block S23.

In an aspect, errors associated with the positioning data obtained from the satellites can be categorized as common errors and non-common errors. Common errors can be corrected by using a same set of attributes for different road users. For example, satellite clock errors, orbit (ephemeris data) errors, errors caused by ionospheric delay, and errors caused by tropospheric delay can be seen as common errors. Non-common errors are associated with the specific GNSS receiver used or the location of the road user. For example, receiver clock errors and errors due to multipath effects can be seen as non-common errors.

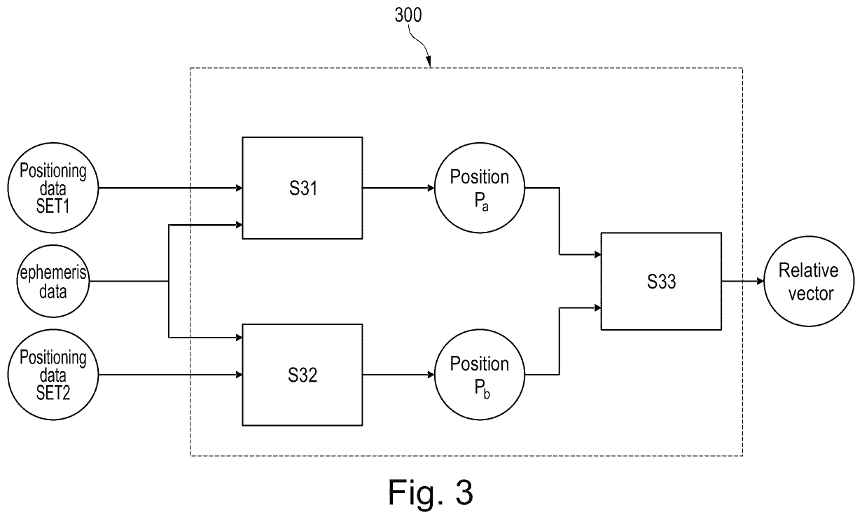

In the following, a more detailed example implementing the techniques disclosed herein will be explained with reference to FIG. 3.

FIG. 3 illustrates a method to determine a relative vector based on the new approach according to some aspects of the disclosure. For simplification, the method 300 shown in FIG. 3 only shows steps for determining a relative vector/relative position between two road users. However, the method can be extended to apply to any number of road users to determine relative vectors and/or relative positions between different pairs of road users.

Steps of the method 300 can be executed by a computing device (e.g., a processor, processing circuit, and/or other suitable component) or other suitable means for performing the steps.

In FIG. 3, blocks S31, S32, S33 are similar as blocks S21, S22, S23 of FIG. 2.

Furthermore, as shown in FIG. 3, the device further receives ephemeris data for determining the estimated positions P_a and P_b. The ephemeris data contains ephemeris information, which can be used to determine positions of the visible GNSS satellites.

At block S31, the device determines an estimated position P_a based on the positioning data of SET1 and the ephemeris data.

At block S32, the device determines an estimated position P_b based on the positioning data of SET2 and the ephemeris data.

This example can be used to understand another advantage of the new approach provided in the present disclosure. By using this new approach, it is possible to use a same set of ephemeris data at block S31 and at block S32. By using the same set of ephemeris data, errors in the ephemeris data may cause similar errors in the estimated positions P_a and P_b, which may cancel each other out at block S33 during determination of the difference between P_a and P_b.

Furthermore, by sharing the same set of ephemeris data, the set of ephemeris data only needs to be determined once, instead of being determined by each GNSS receiver individually.

In a further aspect, the ephemeris data is obtained by the GNSS receiver R_a located at the road user a.

In a further aspect, the device may determine an ephemeris table based on the ephemeris data and uses the ephemeris table at block S31 and at block S32. The ephemeris table may contain satellite orbit information. The ephemeris table may further also contain a method for calculation of positions of the satellites. These satellite positions are used in block S31 and block S32.

In a further aspect, the position data may comprise timestamp information. The timestamp information may be used to determine a position on a given orbit.

In a further aspect, the device may generate a lookup table. When a satellite position is requested, the device may check if the position is already available for a specified timestamp. Otherwise, the device may calculate the position and store it (together with the timestamp) in the lookup table.

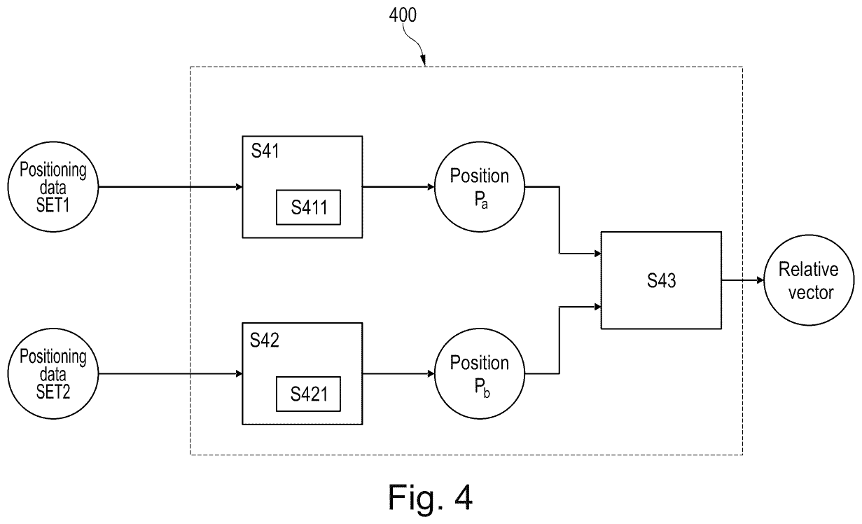

In the following, another more detailed example implementing the techniques disclosed herein will be explained with reference to FIG. 4.

FIG. 4 illustrates a method to determine a relative vector based on the new approach according to some aspects of the disclosure. For simplification, the method 400 shown in FIG. 4 only shows steps for determining a relative vector between two road users. However, the method can be extended to apply to any number of road users to determine relative vectors and/or relative positions between different pairs of road users.

Steps of the method 400 can be executed by a computing device (e.g., a processor, processing circuit, and/or other suitable component) or other suitable means for performing the steps.

In FIG. 4, blocks S41, S42, S43 are similar as blocks S21, S22, S23 of FIG. 2, and also similar as blocks S31, S32, S33 of FIG. 3.

Furthermore, as shown in FIG. 4, block S41 includes a step S411 and block S42 includes a step S421.

At step S411, the device applies an error correcting function to correct errors contained in the positioning data of SET1.

At step S421, the device applies an error correcting function to correct errors contained in the positioning data of SET2.

This example can be used to understand a further advantage of the new approach provided in the present disclosure. By using this new approach, it is possible to use a same error correcting function at step S411 and at step S421. By using the same error correcting function at step S411 and at step S421, it is possible to use a simplified error correcting function. The error correcting function can be simplified in such a way, that the errors caused by the simplification are similar in the estimated position P_a and in the estimated position P_b. Thus, those errors in [symbol] P [symbol] _a and P_b may cancel each other out during the difference calculation at step S43.

As explained above, errors associated with the positioning data obtained by the GNSS receivers can be categorized as common errors and non-common errors.

In one aspect, the error correcting function can be simplified by not including attributes to correct common errors. For example, the error correcting function can be simplified by not including attributes to correct errors caused by ionospheric delay and/or errors caused by tropospheric delay.

In a further aspect, if the positing data SET1 and SET2 are obtained from a same group of satellites, the satellite clock errors can be seen as common errors. In this case, the error correcting function can be further simplified by not including attributes to correct the satellite clock errors.

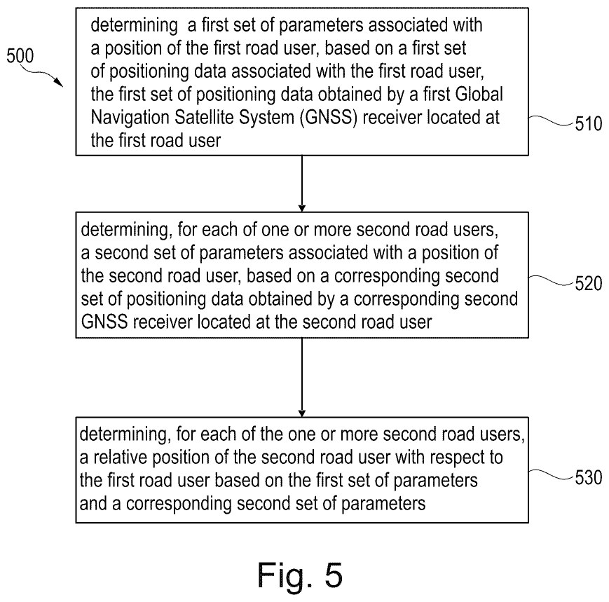

FIG. 5 illustrates a flow diagram of a method to determine a relative vector based on the new approach according to some aspects of the disclosure. Steps of the method 500 can be executed by a computing device (e.g., a processor, processing circuit, and/or other suitable component) or other suitable means for performing the steps. As illustrated, the method 500 includes a number of enumerated steps, but aspects of the method 500 may include additional steps before, after, and in between the enumerated steps.

At block 510, the device determines a first set of parameters associated with a position of the first road user, based on a first set of positioning data associated with the first road user. The first set of positioning data is obtained by a first Global Navigation Satellite System (GNSS) receiver located at the first road user. Here, block 510 can implement similar techniques implemented at block S21 of FIG. 2, block S31 of FIG. 3, and/or block S41 of FIG. 4.

At block 520, the device determines, for each of one or more second road users, a second set of parameters associated with a position of the second road user, based on a corresponding second set of positioning data obtained by a corresponding second GNSS receiver located at the second road user. Here, block 520 can implement similar techniques implemented at block S22 of FIG. 2, block S32 of FIG. 3 and/or block S42 of FIG. 4.

At block 530, the device determines, for each of the one or more second road users, a relative position of the second road user with respect to the first road user based on the first set of parameters and a corresponding second set of parameters. Here, block 530 can implement similar techniques implemented at block S23 of FIG. 2, block S33 of FIG. 3 and/or block S43 of FIG. 4.

In an aspect, the first set of parameters associated with the position of the first road user may represent a first estimated position associated with the first road user, and the second set of parameters associated with the position of the second road user may represent a second estimated position associated with the second road user.

In a further aspect, the block 510 may comprise applying a set of functions to the first set of positioning data, and the block 520 may comprise applying the same set of functions to the second set of positioning data.

In a further aspect, the method 500 may comprise determining an error correction function to correct different types of errors associated with the positioning data in the first set of positioning data and the second set of positioning data, wherein the set of functions may include the error correction function.

In a further aspect, the different types of errors to be corrected by the error correction function may not include satellite clock errors, errors introduced by ionospheric delay, and/or errors introduced by tropospheric delay.

In a further aspect, the block 530 may comprise determining a difference between the first set of parameters and the second set of parameters.

In a further aspect, the method 500 may comprise determining a set of ephemeris parameters based on navigation data, wherein the step of determining the first set of parameters and the step of determining the second set of parameters are further based on the set of ephemeris parameters. The navigation data may be obtained by the first GNSS receiver. In a further aspect, the positioning data may comprise pseudorange measurement data. In a further aspect, the positioning data may comprise timestamp information.

In a further aspect, the method 500 may comprises, for each of one or more second road users, determining a distance between the first road user and the corresponding second road user, based on the determined relative position. Moreover, the method 500 may further comprise, for each of one or more second road users, sending a warning signal to the first road user and/or the corresponding second road user, if the distance is below a threshold distance.

Furthermore, the new approach according to the present disclosure has an advantage over the PRDD-based approach. The PRDD-based approach determines a relative position based on pseudorange double differences (PRDDs) and using a least squares method. A drawback of the PRDD-based approach is that, only positioning data from a group of common satellites (i.e., jointly visible to two road users) can be used in the determination of the PRDDs and the subsequent determination of the relative vector.

By using the new approach according to the present disclosure, it is possible to use positioning data SET1 from a first group of satellites visible to the road user a, and use positioning data SET2 from a second group of satellites visible to the road user b. Here, the first group of satellites and the second group of satellites can have different number of satellites. This is particularly advantageous, for example in a case where road user a is a vehicle equipped with a low-cost GNSS receiver, and the road user b is an infrastructure unit (e.g., an RSU) located at a place with an optimal visibility to the sky so that more satellites are visible to the infrastructure unit. Moreover, locating the infrastructure unit at a place with an optimal visibility to the sky can reduce errors caused by multipath effects in the received positioning data.

In this case, the number of satellites can be maximized for the infrastructure unit. This results in an improved estimated position P_b for the infrastructure unit, which can lead to a more accurate relative vector/relative position estimation between the vehicle and the infrastructure unit.

Furthermore, a known precise position of the infrastructure unit can be used to obtain a more accurate estimation of the position of the vehicle. For example, the more accurate estimation of the position of the vehicle can be obtained based on a relative position (determined based on the new approach disclosed herein) and the known precise position of the infrastructure unit.

In a further aspect, well-known filter techniques (e.g., Kalman filter) and/or multi sensor fusion techniques can be applied at blocks S21, S22 of FIG. 2, at blocks S31, S32 of FIG. 3, at blocks S41, S42 of FIG. 4, and/or at blocks 510, 520 of FIG. 5 to further improve the accuracy of the estimated relative vector/relative position.

In the following, a more detailed example will be explained to show how to simplify the error correcting function to not include attributes to correct errors caused by ionospheric delay and errors caused by tropospheric delay.

In general, a position for a road user can be obtained by solving the following equations

xᵢₜₑᵣ=(A^{T}A)⁻¹A^{T}bᵢₜₑᵣ

x_{new}=x_{old}+xᵢₜₑᵣ.

Here, A is a design matrix, b is a vector with pseudorange residuals for visible satellites (denoted as s₁, s₂, . . . , s_{N} in the following). By applying an iterative least squares method, the above equations can be solved to obtain an estimated position. x_{old} is set to (0,0,0,0)^{T} at the beginning (if the values are unknown). The solution x_{new} is updated with xᵢₜₑᵣ in each iteration until the length |xᵢₜₑᵣ| becomes small enough (compared with a defined threshold value). x_{new} contains the result of the iterative least squares method with the estimated position.

The design matrix A contains line of sight (LoS) unit vectors. For example, the design matrix A can be obtained as:

$$A = [ \begin{matrix}- {e}_{a , x}^{{S}_{1}} & - {e}_{a , y}^{S - 1} & - {e}_{a , z}^{{S}_{1}} & 1 \\ - {e}_{a , x}^{{S}_{2}} & - {e}_{a , y}^{{S}_{2}} & - {e}_{a , z}^{{S}_{2}} & 1 \\ ⋮ & ⋮ & ⋮ & ⋮ \\ - {e}_{a , x}^{{S}_{N}} & - {e}_{a , y}^{{S}_{N}} & - {e}_{a , z}^{{S}_{N}} & 1\end{matrix} ] .$$

Here, the component e is a LoS unit vector for the visible/used satellites.

For example, a LoS unit vector eₐⁱ can be determined as:

$${e}_{a}^{i} = \frac{{P}^{i} - {P}_{a}}{\vert {P}^{i} - {P}_{a} \vert} .$$

Here, Pₐ is a position of road user a in Earth-centered, Earth-fixed (ECEF) coordinates (x, y, z), and pⁱ is a position of satellite i in ECEF coordinates (x,y,z).

The vector b represents pseudorange residuals for visible satellites and contains a list of components bₐⁱ, which can be determined as:

bₐⁱ=pₐⁱ−rₐⁱ+cδtᵤ−cδtₛ−Iₐⁱ−Tₐⁱ−Mₐⁱ−Nₐⁱ.

Here, pₐⁱ is a pseudorange measurement for the road user a and satellite i, rₐⁱ is a geometric distance between the road user a and satellite i (calculated by using Pₐ and Pⁱ), cδtᵤ represents an offset due to receiver clock error, cδtₛ represents an offset due to satellite clock error, Iₐⁱ represents an offset due to ionospheric effects, Tₐⁱ represents an offset due to tropospheric effects, Mₐⁱ represents an offset due to multipath effects, and Nₐⁱ represents an offset due to non-modelled errors.

By applying the techniques disclosed herein, the determination of the components bₐⁱ can be simplified as:

bₐⁱ=pₐⁱ−rₐⁱ+cδtᵤ−cδtₛ−Mₐⁱ−Nₐⁱ.

As can been seen, the simplified version removes the attributes Iₐⁱ (representing an offset due to ionospheric effects) and Tₐⁱ (representing an offset due to tropospheric effects).

Since the attributes Iₐⁱ (representing an offset due to ionospheric effects) and Tₐⁱ (representing an offset due to tropospheric effects) may introduce similar errors in the estimated positions for the road user a and road user b, those errors may cancel each other out when determining the difference between the estimated positions.

In this way, the method to determine the relative vector/relative position is improved to be more efficient.

It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

The term non-transitory computer-readable medium does not encompass transitory electrical or electromagnetic signals propagating through a medium (such as on a carrier wave). Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

1. A computer-implemented method for localizing a first road user, the method comprising:
determining a first set of parameters associated with a position of the first road user, based on a first set of positioning data associated with the first road user, wherein:
the first set of positioning data is obtained by a first Global Navigation Satellite System (GNSS) receiver located at the first road user, and
the first set of parameters represents a first estimated position associated with the first road user;
for each of one or more second road users:
determining a second set of parameters associated with a position of the second road user, based on a corresponding second set of positioning data obtained by a corresponding second GNSS receiver located at the second road user, wherein the second set of parameters represents a second estimated position associated with the second road user, and
determining a relative position of the second road user with respect to the first road user based on the first set of parameters and a corresponding second set of parameters; and
determining a set of ephemeris parameters based on navigation data obtained by the first GNSS receiver, wherein determining the first set of parameters and determining the second set of parameters are further based on the set of ephemeris parameters.

2. The method of claim 1 wherein:
determining the first set of parameters includes applying a set of functions to the first set of positioning data, and
determining the second set of parameters includes applying the set of functions to the second set of positioning data.

3. The method of claim 2 further comprising:
determining an error correction function to correct different types of errors associated with positioning data in the first set of positioning data and the second set of positioning data,
wherein the set of functions includes the error correction function.

4. The method of claim 3 wherein the different types of errors to be corrected by the error correction function exclude at least one of satellite clock errors, errors introduced by ionospheric delay, or errors introduced by tropospheric delay.

5. The method of claim 1 wherein determining the relative position of the second road user includes determining a difference between the first set of parameters and the second set of parameters.

6. The method of claim 5 wherein positioning data in at least one of the first set of positioning data or the second set of positioning data includes pseudorange measurement data.

7. The method of claim 5 wherein positioning data in at least one of the first set of positioning data or the second set of positioning data includes timestamp information.

8. The method of claim 1 further comprising, for each of the one or more second road users, determining a distance between the first road user and the corresponding second road user, based on the determined relative position.

9. The method of claim 8 further comprising, for each of the one or more second road users, in response to the distance being below a threshold distance, sending a warning signal to at least one of the first road user or the corresponding second road user.

10. An apparatus comprising:
a computer-readable medium storing instructions; and
at least one processor configured to execute the instructions, wherein the instructions include:
determining a first set of parameters associated with a position of a first road user, based on a first set of positioning data associated with the first road user, wherein:
the first set of positioning data is obtained by a first Global Navigation Satellite System (GNSS) receiver located at the first road user, and
the first set of parameters represents a first estimated position associated with the first road user;
for each of one or more second road users:
determining a second set of parameters associated with a position of the second road user, based on a corresponding second set of positioning data obtained by a corresponding second GNSS receiver located at the second road user, wherein the second set of parameters represents a second estimated position associated with the second road user, and
determining a relative position of the second road user with respect to the first road user based on the first set of parameters and a corresponding second set of parameters; and
determining a set of ephemeris parameters based on navigation data obtained by the first GNSS receiver, wherein determining the first set of parameters and determining the second set of parameters are further based on the set of ephemeris parameters.

11. The apparatus of claim 10 wherein the apparatus is located at the first road user or in a cloud system.

12. A non-transitory computer readable medium comprising instructions including:
determining a first set of parameters associated with a position of a first road user, based on a first set of positioning data associated with the first road user, wherein:
the first set of positioning data is obtained by a first Global Navigation Satellite System (GNSS) receiver located at the first road user, and
the first set of parameters represents a first estimated position associated with the first road user;
for each of one or more second road users:
determining a second set of parameters associated with a position of the second road user, based on a corresponding second set of positioning data obtained by a corresponding second GNSS receiver located at the second road user, wherein the second set of parameters represents a second estimated position associated with the second road user, and
determining a relative position of the second road user with respect to the first road user based on the first set of parameters and a corresponding second set of parameters; and
determining a set of ephemeris parameters based on navigation data obtained by the first GNSS receiver, wherein determining the first set of parameters and determining the second set of parameters are further based on the set of ephemeris parameters.
